(19) United States
(12) Patent Application Publication
(10) Pub. No.: US 2026/0349226 A1
(43) Pub. Date: Nov. 5, 2026

(54) OPTICAL SYSTEM AND IMAGE PICKUP APPARATUS

(71) Applicant: CANON KABUSHIKI KAISHA, Tokyo (JP)

(72) Inventor: Maki YOKOYA, Tochigi (JP)

(21) Appl. No.: 19/716,250

(22) Filed: Jun. 23, 2026

Related U.S. Application Data
(63) Continuation of application No. PCT/JP2024/040962, filed on Nov. 19, 2024.

(30) Foreign Application Priority Data
Feb. 21, 2024 (JP) 2024-024870

(51) Int. Cl. G02B 13/06; G02B 3/00; G02B 13/18

(52) U.S. Cl. CPC G02B 13/06; G02B 13/18; G02B 2003/0093

(57) ABSTRACT

An optical system includes a first negative lens. Predetermined inequalities are satisfied.

### CROSS-REFERENCE TO RELATED APPLICATIONS

This application is a Continuation of International Patent Application No. PCT/JP2024/040962, filed on Nov. 19, 2024, which claims the benefit of Japanese Patent Application No. 2024-024870, filed on Feb. 21, 2024, both of which are hereby incorporated by reference herein in their entirety.

### BACKGROUND

### Field of the Technology

The present disclosure relates to an optical system for omnidirectional imaging, and an image pickup apparatus.

### Description of the Related Art

In a case where an angle of view of 360° cannot be obtained for a single optical system during omnidirectional imaging, stitching processing is performed to join together a plurality of captured images obtained using a plurality of optical systems and image sensors respectively provided for the optical systems, as disclosed in Japanese Patent Application Laid-Open No. 2013-025255.

However, the stitching processing may cause inconsistency at boundaries between captured images due to displacement of nodal points (entrance pupils) of the plurality of optical systems. As a result, it is difficult to obtain a high-quality omnidirectional image.

### SUMMARY

One aspect of the present disclosure provides an optical system that includes a first negative lens. The following inequalities are satisfied:

90°<θ1≤180°

−75.0≤FG1/|f|≤−47.2
where θ1 is a half opening angle at an effective diameter position of an object-side lens surface of the first negative lens, FG1 is a focal length of the first negative lens, and f is a focal length of the optical system. Another aspect of the present disclosure provides an optical system that includes, in order from an object side to an image side, a first lens unit having positive refractive power, an aperture stop, and a second lens unit having positive refractive power. The first lens unit includes a first negative lens. The following inequality is satisfied:

90°<θ1≤180°
where θ1 is a half opening angle at an effective diameter position of an object-side lens surface of the first negative lens. An image pickup apparatus having any one of the above optical systems also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating the configuration and optical paths of an optical system according to Example 1.

FIG. 2 is a longitudinal aberration diagram of the optical system according to Example 1.

FIG. 3 is a cross-sectional view illustrating the configuration and optical paths of an optical system according to Example 2.

FIG. 4 is a longitudinal aberration diagram of the optical system according to Example 2.

FIG. 5 illustrates an image pickup apparatus including the optical system according to Example 1 or 2.

### DESCRIPTION OF THE EMBODIMENTS

Referring now to the accompanying drawings, a description will be given of examples according to the present disclosure.

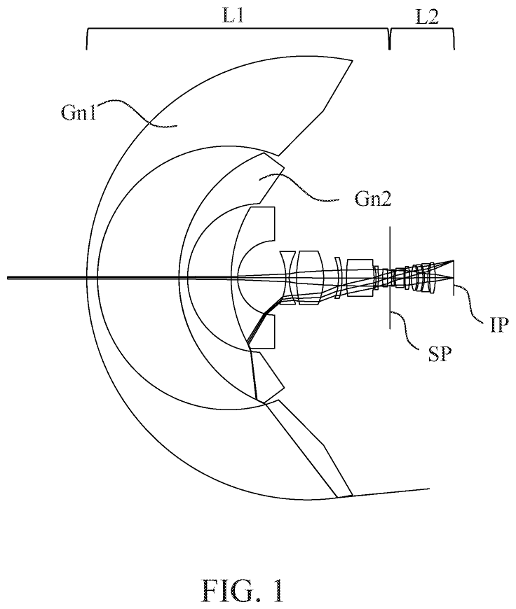

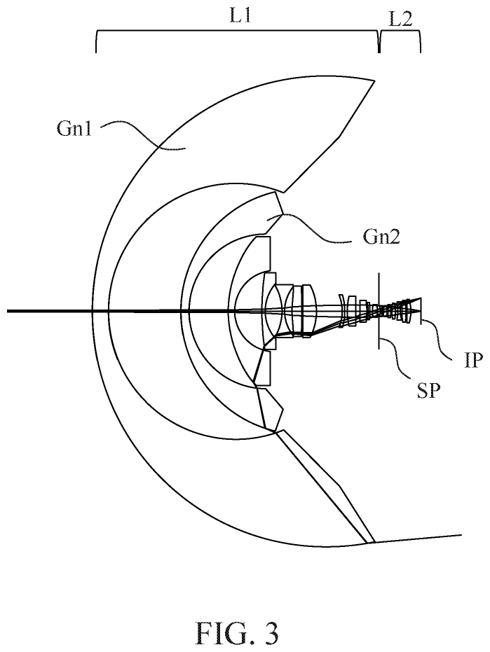

FIGS. 1 and 3 respectively illustrate cross-sections of optical systems according to Example 1 and Example 2. These figures also illustrate optical paths of on-axis light beams and light beams at a maximum half angle of view. In each figure, a left side is an object side (front side), and a right side is an image side (rear side).

The optical system according to example is used, as an imaging optical system, in an image pickup apparatus such as a digital camera, a video camera, a broadcasting camera, a cinema camera, a surveillance camera, or a film-based camera.

The optical system according to example forms an optical image of an object (not illustrated) located on the object side. On an image plane IP, an imaging surface (light receiving surface) of an image sensor such as a CCD sensor or a CMOS sensor, or a film surface (photosensitive surface) of silver-halide film, is disposed.

The optical system according to example may also be used as a projection optical system for an image display apparatus, which enlarges light from a display element such as a liquid crystal panel or a digital micromirror device disposed at a position corresponding to the image plane IP and projects the light onto a projection surface such as a spherical screen. In this case, the object side in each figure serves as a magnification conjugate side, and the image side serves as a reduction conjugate side.

The optical system according to example includes, in order from the object side to the image side, a first lens unit L1 having positive refractive power, an aperture stop SP, and a second lens unit L2 having positive refractive power. The first lens unit L1 includes a first negative lens Gn1, which is a negative meniscus lens disposed closest to the object. A light-transmitting member other than a lens, such as a cover glass having no or substantially no refractive power, may be disposed on the object side of (closer to the object than) the first negative lens Gn1. Each lens unit includes one or more lenses.

An object-side lens surface of the first negative lens Gn1 has a half opening angle exceeding 90° at an effective diameter position thereof (described later). That is, where θ1 is the half opening angle at an effective diameter position of the object-side lens surface of (closer to the object than) the first negative lens Gn1, the following Inequality (1) is satisfied:

90°<θ1≤180° (1)

The effective diameter position is a position of an intersection between the lens surface and a marginal ray. The marginal ray is a ray having an intersection with the lens surface at a position farthest from a surface vertex of the lens surface along the optical axis among rays passing through the lens surface.

With a first negative lens having a half opening angle θ1 of 90° or less, it is impossible to capture light rays having a half angle of view of 180° or more that wrap around from the image side for the optical system. In order to capture light rays having a half angle of view of 180° or more, a first negative lens having a half opening angle greater than 90° is required, and a larger half opening angle may be used in order to capture light rays having a wider angle of view.

The numerical range of Inequality (1) may be set as follows:

92.6°≤θ1≤153.4° (1a)

The numerical range of Inequality (1) may be set as follows:

95.3°≤θ1≤126.7° (1b)

Such a lens having a half opening angle exceeding 90° can be manufactured, for example, by manufacturing split shapes divided by a plane parallel to the optical axis and then bonding them together by adhesion or the like.

Satisfying the above-described configuration and conditions can provide a high-quality omnidirectional image without seam inconsistency unlike the conventional configuration.

Next, the conditions and configurations that may be satisfied by the optical system according to example will be described. The optical system according to example may satisfy at least one of the following conditions and configurations of Inequalities (3) to (8).

The optical system according to example may include a plurality of lenses on the image side of (closer to the image plane than) the first negative lens Gn1. By including a plurality of lenses on the image side of the first negative lens Gn1, the optical system can capture light rays having a half angle of view of 180° or more by the first negative lens Gn1 disposed closest to the object and can satisfactorily form an image of the light rays by the plurality of lenses disposed on the image side thereof.

Where θ2 is a half opening angle at an effective diameter position of an image-side lens surface of the first negative lens Gn1, the optical system according to example may satisfy the following Inequality (2):

90°<θ2≤180° (2)

A first negative lens having a half opening angle θ2 of 90° or less on the image-side lens surface may not be used because it is difficult to capture light rays having a half angle of view of 180° or more.

The numerical range of Inequality (2) may be set as follows:

95.5°≤θ2≤156.1° (2a)

The numerical range of Inequality (2) may be set as follows:

100.9°≤θ2≤132.1° (2b)

Where FG1 is a focal length of the first negative lens Gn1 and f is a focal length of the optical system, the optical system according to example may satisfy the following Inequality (3):

−75.0≤FG1/|f|≤−30.0 (3)

In a case where the refractive power of the first negative lens Gn1 increases such that FG1/|f| becomes lower than the lower limit of Inequality (3), off-axis aberrations such as field curvature, astigmatism, and lateral chromatic aberration increase, making it difficult to obtain a high-quality omnidirectional image. In a case where the refractive power of the first negative lens Gn1 decreases such that FG1/|f| becomes higher than the upper limit of Inequality (3), light rays having a half angle of view exceeding 180° cannot be captured.

The numerical range of Inequality (3) may be set as follows:

−68.2≤FG1/|f|≤−38.6 (3a)

The numerical range of Inequality (3) may be set as follows:

−64.9≤FG1/|f≤−47.2 (3b)

Where nd is the refractive index of the first negative lens Gn1 at the d-line (wavelength of 587.6 nm), the optical system according to example may satisfy the following Inequality (4):

1.6≤nd≤2.3 (4)

In a case where the refractive index of the first negative lens Gn1 decreases such that nd becomes lower than the lower limit of Inequality (4), light rays having a half angle of view exceeding 180° cannot be captured. In a case where the refractive index of the first negative lens Gn1 increases such that nd becomes higher than the upper limit of Inequality (4), the lens material generally becomes a high-dispersion material, thereby causing large lateral chromatic aberration and making it difficult to obtain a high-quality omnidirectional image.

The numerical range of Inequality (4) may be set as follows:

1.7≤nd≤2.2 (4a)

The numerical range of Inequality (4) may be set as follows:

1.9≤nd≤2.1 (4b)

Where R1 is a radius of curvature of an object-side lens surface of the first negative lens Gn1, R2 denotes a radius of curvature of an image-side lens surface of the first negative lens Gn1, and a shape factor S is defined as S=(R1+R2)/(R1−R2), the optical system according to example may satisfy the following Inequality (5):

2.0≤S≤5.5 (5)

In a case where S becomes lower than the lower limit of Inequality (5), the refractive power of the first negative lens Gn1 increases, thereby causing large off-axis aberrations such as field curvature, astigmatism, and lateral chromatic aberration, and making it difficult to obtain a high-quality omnidirectional image. In a case where S becomes higher than the upper limit of Inequality (5), the refractive power of the first negative lens Gn1 decreases, thereby making it difficult to capture light rays having a half angle of view of 180° or more.

The numerical range of Inequality (5) may be set as follows:

2.6≤S≤5.0 (5a)

The numerical range of Inequality (5) may be set as follows:

3.0≤S≤4.4 (5b)

Where ω is a maximum half angle of view, the optical system according to example may satisfy the following Inequality (6):

180.0°≤ω (6)

In a case where @ becomes lower than the lower limit of Inequality (6), a part of an omnidirectional image is missing.

The numerical range of Inequality (6) may be set as follows:

181.7°≤ω (6a)

The numerical range of Inequality (6) may be set as follows:

183.3°≤ω (6b)

Where D1 is a distance on the optical axis from an object-side lens surface of the first negative lens Gn1 to the aperture stop SP, and D2 is a distance on the optical axis from the aperture stop SP to the image plane IP, the optical system according to example may satisfy the following Inequality (7):

3.0≤D1/D2≤12.0 (7)

In a case where D1/D2 becomes lower than the lower limit of Inequality (7), D1 becomes excessively short, and the refractive power of each lens including the first negative lens Gn1 on the object side of the aperture stop SP becomes excessively strong. As a result, particularly because the refractive power of a lens through which off-axis light rays pass at high positions becomes excessively strong, off-axis aberrations such as field curvature, astigmatism, and lateral chromatic aberration become large, making it impossible to obtain a high-quality omnidirectional image. In a case where D1/D2 becomes higher than the upper limit of Inequality (7), D1 becomes excessively long, and the diameter of the lens G1 disposed closest to the object becomes excessively large.

The numerical range of Inequality (7) may be set as follows:

3.6≤D1/D2≤10.3 (7a)

The numerical range of Inequality (7) may be set as follows:

4.1≤D1/D2≤8.5 (7b)

Where f1 is a focal length of the first lens unit L1 and f is a focal length of the entire optical system, the optical system according to example may satisfy the following Inequality (8):

0.5≤f1/f≤2.2 (8)

The first lens unit L1 includes an object-side negative unit and an image-side positive unit in order to capture wide-angle light rays. In this case, in a case where f1/f becomes lower than the lower limit of Inequality (8), the refractive power of the object-side negative unit of the first lens unit L1 reduces, thereby making it difficult to capture wide-angle light rays. In a case where f1/f becomes higher than the upper limit of Inequality (8), the refractive power of the object-side negative unit of the first lens unit L1 increases, thereby causing large off-axis aberrations such as field curvature, astigmatism, and lateral chromatic aberration, and making it difficult to obtain a high-quality omnidirectional image.

The numerical range of Inequality (8) may be set as follows:

0.7≤f1/f≤1.9 (8a)

The numerical range of Inequality (8) may be set as follows:

0.8≤f1/f≤1.5 (8b)

The optical system (the first lens unit L1) according to example may include a second negative lens Gn2 adjacent to and disposed closer to the image plane than the first negative lens Gn1. Where θ3 and θ4 respectively are half opening angles at effective diameter positions of object-side and image-side lens surfaces of the second negative lens Gn2, the following inequalities (9) and (10) may be satisfied. Inequality (9) may be replaced with inequality (9a) or (9b). Inequality (10) may be replaced with inequality (10a) or (10b).

40°<θ3≤100° (9)

65°<θ4<110° (10)

48.2°<θ3≤90.7° (9a)

70.4°<θ4≤101.1° (10a)

56.3°<θ3≤81.3° (9b)

75.8°<θ4≤92.2° (10b)

The optical system according to Example 1 includes the first negative lens Gn1, the second negative lens Gn2, and two negative lenses as negative single lenses continuously arranged in order from the object side in the first lens unit L1. The optical system according to Example 2 includes the first negative lens Gn1, the second negative lens Gn2, and three negative lenses as negative single lenses continuously arranged in order from the object side in the first lens unit L1.

Numerical examples 1 and 2 respectively corresponding to Examples 1 and 2 will be described below. In each numerical example, a surface number i denotes an order of a surface counted from the object side. r denotes a radius of curvature (mm) of the i-th surface counted from the object side, and d denotes a lens thickness or an air gap (mm) on the optical axis between the i-th surface and the (i+1)-th surface. nd denotes a refractive index at the d-line of an optical material between the i-th surface and the (i+1)-th surface. vd denotes an Abbe number based on the d-line of the optical material between the i-th surface and the (i+1)-th surface.

The Abbe number vd based on the d-line is represented by vd=(Nd−1)/(NF−NC), where Nd, NF, and NC are refractive indices at the d-line (587.6 nm), F-line (486.1 nm), and C-line (656.3 nm), respectively, in the Fraunhofer line.

All of the distance d, focal length (mm), F-number (Fno), and half angle of view) (°) are values in a state in which the optical system according to each numerical example is in an in-focus state on an object at infinity. BF denotes a back focus (mm). The back focus is represented by an air-converted length of a distance on the optical axis from a lens surface closest to the image plane of the optical system to the paraxial image plane. An overall lens length is a distance obtained by adding the back focus to a distance on the optical axis from a lens surface closest to the object of the optical system to the lens surface closest to the image plane of the optical system.

An asterisk “*” attached to a surface number means that the surface has an aspherical shape. The aspherical shape is represented by the following equation:

x=(h²/R)/[1+{1−(1+K)(h/R)²}]^{1/2}+A4×h⁴+A6×h⁶+A8×h⁸+A10×h¹⁰
where x denotes a displacement amount from a surface vertex in the optical axis direction, h denotes a height from the optical axis in a direction orthogonal to the optical axis, a light traveling direction is positive, R denotes a paraxial radius of curvature, K denotes a conic constant, and A4, A6, A8, and A10 denote aspherical coefficients. “e±Z” of the conic constant and the aspherical coefficients means×10^{±Z}.

Table 1 summarizes the values of Inequalities (1) to (8) in numerical examples 1 and 2. Both numerical examples use the d-line as a reference wavelength, and the values illustrated in Table 1 are values at this reference wavelength. The optical systems according to the respective numerical examples satisfy all of Inequalities (1) to (8).

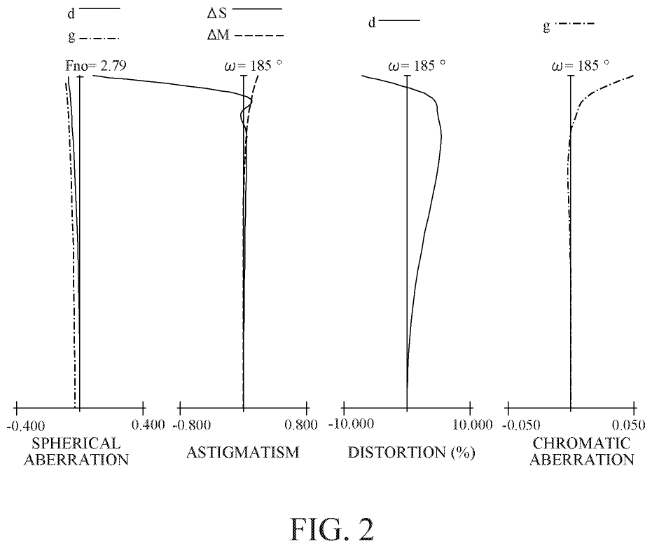

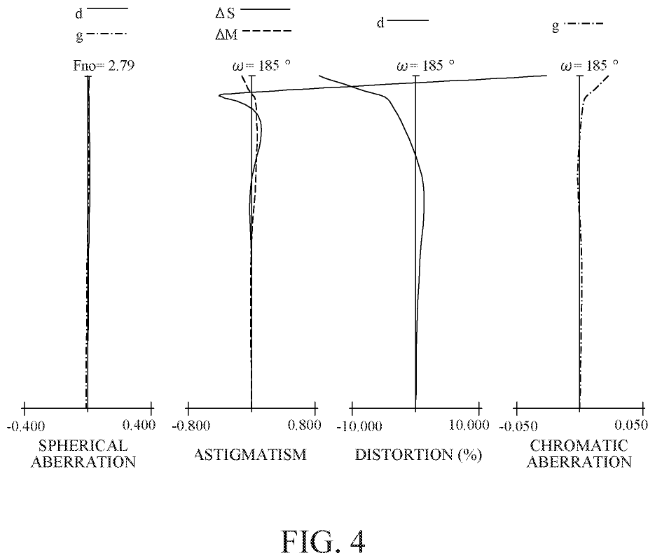

FIGS. 2 and 4 respectively illustrate longitudinal aberrations (spherical aberration, astigmatism, distortion, and chromatic aberration) of the optical systems according to numerical examples 1 and 2 in an in-focus state on an object at infinity. In each spherical aberration diagram, Fno denotes an F-number. A solid line illustrates a spherical aberration amount for the d-line (wavelength: 587.6 nm), and an alternate long and short dash line illustrates a spherical aberration amount for the g-line (wavelength: 435.8 nm). In each astigmatism diagram, a solid line AS illustrates an astigmatism amount on a sagittal image plane, and a broken line AM illustrates an astigmatism amount on a meridional image plane. Each distortion aberration diagram illustrates a distortion aberration amount for the d-line. The distortion aberration is calculated based on equidistant projection. Each chromatic aberration diagram illustrates a lateral chromatic aberration amount for the g-line. ω denotes a half angle of view) (°).

### Numerical Example 1

UNIT: mm

### Surface Data

NUMERICAL EXAMPLE 1
UNIT: mm
SURFACE DATA

| Surface No. | r | d | nd | νd |
|---|---|---|---|---|
| 1 | 51.037 | 2.50 | 2.00502 | 28.9 |
| 2 | 30.339 | 18.85 | | |
| 3 | 30.875 | 2.00 | 1.90984 | 36.4 |
| 4 | 17.114 | 10.08 | | |
| 5 | 31.645 | 1.50 | 1.96763 | 25.9 |
| 6 | 8.583 | 11.13 | | |
| 7 | −14.184 | 0.80 | 1.87280 | 40.5 |
| 8 | 12.756 | 1.72 | | |
| 9 | 26.631 | 6.23 | 1.87141 | 23.6 |
| 10 | −15.148 | 3.46 | | |
| 11 | −13.598 | 0.80 | 1.92845 | 34.6 |
| 12 | −17.977 | 1.04 | | |
| 13 | 31.410 | 6.38 | 1.71016 | 30.9 |
| 14 | −15.500 | 0.48 | | |
| 15 | −9.748 | 0.50 | 1.49802 | 79.3 |
| 16 | −79.400 | 1.00 | | |
| 17 | 17.151 | 1.19 | 1.91277 | 36.1 |
| 18 | −25.037 | 0.53 | | |
| 19 (SP) | ∞ | 0.41 | | |
| 20 | −13.139 | 0.50 | 1.82135 | 22.9 |
| 21 | 10.101 | 0.30 | | |
| 22 | 9.772 | 2.02 | 1.78043 | 48.7 |
| 23 | 145.789 | 0.30 | | |
| 24 | 150.450 | 1.03 | 1.76147 | 50.7 |
| 25 | −12.785 | 0.40 | | |
| 26 | 8.793 | 1.35 | 1.50466 | 80.3 |
| 27 | −9.126 | 0.32 | | |
| 28 | −8.598 | 1.00 | 1.80815 | 22.8 |
| 29 | −9.445 | 0.36 | | |
| 30 | −7.249 | 0.80 | 1.81135 | 22.8 |
| 31 | 12.536 | 0.39 | | |
| 32 | 23.338 | 1.34 | 1.72923 | 54.7 |
| 33 | −14.200 | 4.34 | | |
| Image Plane | ∞ | | | |

VARIOUS DATA

| | |
|---|---|
| Focal Length | 1.42 |
| Fno | 2.79 |
| Half Angle of View (°) | 185.0 |
| Image Height | 4.00 |
| Overall Lens Length | 85.02 |
| BF | 4.34 |

LENS UNIT DATA

| Lens Unit | Starting Surface | Focal Length |
|---|---|---|
| 1 | 1 | 1.64 |
| 2 | 19 | 27.57 |

NUMERICAL EXAMPLE 2
UNIT: mm
SURFACE DATA

| Surface No. | r | d | nd | νd |
|---|---|---|---|---|
| 1 | 71.897 | 5.00 | 2.00100 | 29.1 |
| 2 | 39.099 | 22.20 | | |
| 3 | 37.580 | 2.50 | 2.00100 | 29.1 |
| 4 | 23.676 | 12.00 | | |
| 5* | 31.554 | 2.00 | 1.88668 | 38.8 |
| 6 | 12.410 | 8.37 | | |
| 7 | 78.963 | 1.00 | 1.59522 | 67.7 |
| 8 | 12.638 | 5.16 | | |
| 9 | −15.698 | 0.80 | 1.59522 | 67.7 |
| 10 | 11.710 | 2.30 | | |
| 11* | 40.794 | 2.95 | 1.96568 | 24.9 |
| 12 | −509.283 | 0.30 | | |
| 13 | 1062.045 | 4.21 | 1.93160 | 33.8 |
| 14* | −17.841 | 7.92 | | |
| 15* | −12.309 | 0.80 | 1.81466 | 22.8 |
| 16 | −16.614 | 0.75 | | |
| 17 | 20.369 | 2.64 | 1.59513 | 67.5 |
| 18 | 341.584 | 1.20 | | |
| 19 | 273.339 | 2.16 | 1.72922 | 54.7 |
| 20 | −16.554 | 0.41 | | |
| 21 | −9.991 | 0.50 | 1.49700 | 81.5 |
| 22 | −37.488 | 0.85 | | |
| 23 | 15.501 | 1.48 | 1.80725 | 46.0 |
| 24 | −23.981 | 0.48 | | |
| 25 (SP) | ∞ | 0.39 | | |
| 26* | −12.961 | 0.50 | 1.69301 | 29.3 |
| 27 | 10.172 | 0.47 | | |
| 28 | 11.950 | 1.09 | 1.73908 | 53.4 |
| 29 | 189.429 | 0.30 | | |
| 30 | 299.903 | 0.91 | 1.65588 | 61.0 |
| 31 | −14.519 | 0.31 | | |
| 32 | 10.859 | 1.11 | 1.49700 | 81.5 |
| 33 | −11.802 | 0.75 | | |
| 34 | −10.865 | 0.80 | 1.80810 | 22.8 |
| 35 | 12.142 | 0.44 | | |
| 36 | 25.444 | 1.20 | 1.77250 | 49.6 |
| 37* | −141.365 | 0.30 | | |
| 38 | 209.095 | 1.21 | 1.59522 | 67.7 |
| 39 | −13.727 | 3.10 | | |
| Image Plane | ∞ | | | |

### Aspheric Data

5th Surface
K=0.00000e+00 A 4=−8.10166e-06 A 6=1.38874e-08 A 8=−3.09318e-11
A10=3.96310e-14
11th Surface
K=0.00000e+00 A 4=−2.38743e-05 A 6=−8.27601e-07 A 8=−7.32387e-09
A10=−2.64958e-11
14th Surface
K=0.00000e+00 A 4=−2.21199e-06 A 6=−3.65149e-07 A 8=−4.42720e-10
A10=2.22297e-11
15th Surface
K=0.00000e+00 A 4=8.11020e-05 A 6=−2.08816e-08 A 8=1.94718e-07
A10=−4.55195e-09
26th Surface
K=0.00000e+00 A 4=−2.50906e-04 A 6=−1.88517e-04 A 8=1.20885e-04
A10=−2.18158e-05
37th Surface
K=0.00000e+00 A 4=−5.47859e-05 A 6=−2.97190e-05 A 8=4.25749e-07
A10=−1.66408e-07

VARIOUS DATA

| | |
|---|---|
| Focal Length | 1.55 |
| Fno | 2.79 |
| Half Angle of View (°) | 185.0 |
| Image Height | 4.00 |
| Overall Lens Length | 100.86 |
| BF | 3.10 |

LENS UNIT DATA

| Lens Unit | Starting Surface | Focal Length |
|---|---|---|
| 1 | 1 | 1.57 |
| 2 | 25 | 27.93 |

TABLE 1

| | Numerical | Numerical |
|---|---|---|
| | Example 1 | Example 2 |
| Inequality (1) | 100.1 | 97.9 |
| Inequality (2) | 108.2 | 106.4 |
| Inequality (3) | −59.9 | −55.8 |
| Inequality (4) | 2.001 | 2.005 |
| Inequality (5) | 3.4 | 3.9 |
| Inequality (6) | 185 | 185 |
| Inequality (7) | 6.8 | 4.7 |
| Inequality (8) | 1 | 1.2 |
| Inequality (9) | 64.5 | 72.0 |
| Inequality (10) | 81.2 | 83.3 |

### Image Pickup Apparatus

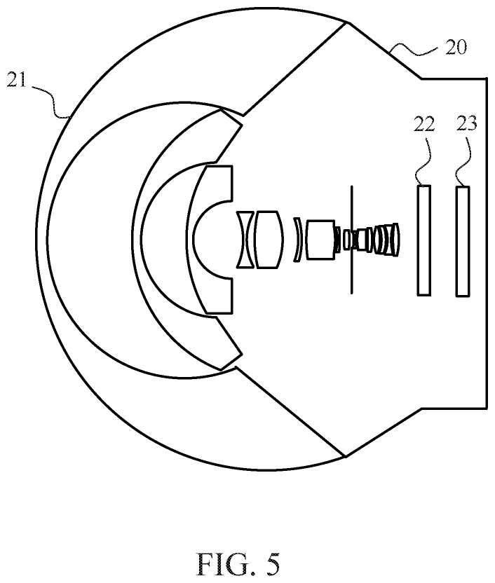

FIG. 5 illustrates an omnidirectional digital camera serving as an image pickup apparatus using the optical system of any one of the above examples as an imaging optical system. Reference numeral 20 denotes a camera body, and reference numeral 21 denotes an imaging optical system including the optical system according to Example 1 or 2. Reference numeral 22 denotes a solid-state image sensor such as a CCD sensor or a CMOS sensor, which is built into the camera body 20 and photoelectrically converts an optical image (object image) formed by the imaging optical system 21, that is, captures the object image through the imaging optical system 21. Reference numeral 23 denotes a recorder configured to record image data generated by processing an imaging signal from the image sensor 22.

The optical system according to each example can provide an omnidirectional digital camera capable of obtaining a high-quality omnidirectional image as a captured image. The imaging optical system may be detachable (replaceable) from the camera body.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An optical system comprising:
a first negative lens,
wherein the following inequalities are satisfied:
90°<θ1≤180°
−75.0≤FG1/|f|≤−47.2
where θ1 is a half opening angle at an effective diameter position of an object-side lens surface of the first negative lens, FG1 is a focal length of the first negative lens, and f is a focal length of the optical system.

2. The optical system according to claim 1, wherein the following inequality is satisfied:
90°<θ2≤180°
where θ2 is a half opening angle at an effective diameter position of an image-side lens surface of the first negative lens.

3. The optical system according to claim 1, wherein the following inequality is satisfied:
1.6≤nd≤2.3
where nd is a refractive index of the first negative lens at d-line.

4. The optical system according to claim 1, wherein the following inequality is satisfied:
2.0≤S≤5.5
where S=(R1+R2)/(R1−R2), R1 is a radius of curvature of the object-side lens surface of the first negative lens, and R2 is a radius of curvature of an image-side lens surface of the first negative lens.

5. The optical system according to claim 1, wherein the following inequality is satisfied:
180.0°≤ω
where ω is a maximum half angle of view of the optical system.

6. The optical system according to claim 1, further comprising an aperture stop,
wherein the following inequality is satisfied:
3.0≤D1/D2≤12.0
where D1 is a distance on an optical axis from the object-side lens surface of the first negative lens to the aperture stop, and D2 is a distance on the optical axis from the aperture stop to an image plane.

7. The optical system according to claim 1, comprising, in order from an object side to an image side, a first lens unit having positive refractive power, an aperture stop, and a second lens unit having positive refractive power,
wherein the following inequality is satisfied:
0.5≤f1/f≤2.2
where f1 is a focal length of the first lens unit, and f is a focal length of the optical system.

8. The optical system according to claim 1, further comprising a second negative lens adjacent to and disposed closer to an image plane than the first negative lens,
wherein the following inequalities are satisfied:
40°<θ3≤100°
65°<θ4≤110°
where θ3 and θ4 respectively are half opening angles at effective diameter positions of an object-side lens surface of the second negative lens and an image-side lens surface of the second negative lens.

9. The optical system according to claim 8, comprising, as negative lenses that are single lenses continuously arranged in order from an object side, the first negative lens, the second negative lens, and at least two negative lenses.

10. An image pickup apparatus comprising:
an optical system; and
an image sensor configured to capture an image of an object through the optical system,
wherein the optical system includes a first negative lens, and
wherein the following inequalities are satisfied:
90°<θ1≤180°
−75.0≤FG1/|f|≤−47.2
where θ1 is a half opening angle at an effective diameter position of an object-side lens surface of the first negative lens, FG1 is a focal length of the first negative lens, and f is a focal length of the optical system.

11. An optical system comprising, in order from an object side to an image side:
a first lens unit having positive refractive power;
an aperture stop; and
a second lens unit having positive refractive power,
wherein the first lens unit includes a first negative lens,
wherein the following inequality is satisfied:
90°<θ1≤180°
where θ1 is a half opening angle at an effective diameter position of an object-side lens surface of the first negative lens.
